(19) United States
(12) Patent Application Publication
(10) Pub. No.: US 2004/0039191 A1
(43) Pub. Date: Feb. 26, 2004

(54) Method for producing highly-substituted carboxyalkyl starch

(76) Inventors: Bert Volkert, Berlin (DE); Fritz Loth, Teltow (DE); Waldemar Lazik, Pirna-Ot Graupa (DE); Wolfgang Koch, Bomlitz (DE); Alexandra Hild, Soltau (DE)

Correspondence Address: D Edward Dolgorukov, Marshall & Melhorn, Eighth Floor, Four SeaGate, Toledo, OH, 43604, US

(21) Appl. No.: 10/312,096

(22) PCT Filed: Jun. 29, 2001
(86) PCT No.: PCT/EP01/07488

(30) Foreign Application Priority Data
Jul. 7, 2000 (DE) 100 33 197.1

(51) Int. Cl. C08B 31/08

(52) U.S. Cl. 536/111

(57) ABSTRACT

The invention relates to a highly substituted carboxyalkyl starch which is obtained by a special slurry method. A conversion of starch with halogenated acids is thereby effected in an organic-aqueous reaction medium in the presence of alkali hydroxide. This starch is used in the chemical industry field.

The invention relates to a highly substituted carboxyalkyl starch which is obtained by a special slurry method. This starch is used in the chemical industry field.

Normally, carboxymethyl starch is produced in that either starch is converted in aqueous suspension in the presence of inert salts and alkali hydroxide with monochloroacetic acid or its sodium salt, or the starch is dissolved in an excess of aqueous alkali and the solution is made to convert with monochloroacetic acid or its sodium salt. Products with only low substitution rates, as a rule <0.25 are thereby obtained.

In order to produce more highly substituted carboxymethyl starch, the starch, as described in Starch/Stärke 51, (1999) No. 1, 16-20, can be dissolved in DMSO, alkalised with alkali hydroxide and converted with the sodium salt of the monochloroacetic acid. A substitution rate of up to 1.68 is achieved. A significant disadvantage of the homogeneous synthesis variant is the difficult processing and cleaning of the product since it must be precipitated once again out of the dissolved state.

The production in suspension with aqueous-organic reaction media is also known. For example in the case of the method known from U.S. Pat. No. 4,716,186 for producing carboxymethyl starch, the starch is therefore suspended in an aqueous-organic reaction medium, alkalised with alkali hydroxide and carboxymethylated with monochloroacetic acid. Products with substitution rates up to 1 are claimed, only substitution rates of max. 0.43 being described experimentally.

In the case of production of carboxymethyl starch described in U.S. Pat. No. 5,811,541, the starch is initially suspended in the presence of monochloroacetic acid in an organic solvent. By the addition of aqueous alkali, the starch is converted. Low substitution rates are produced in the range up to 0.2.

A corresponding method for producing carboxymethyl starch with a higher substitution rate up to 1.4 is described in Journal of Applied Polymer Science, Vol. 24, (1979), 2031-2040 in that the conversion is effected with monochloroacetic acid in two complete reaction steps.

A substantial problem during carboxymethylation of starch into products with high substitution rates is the problem of agglutination of the reaction products during the reaction. Reference to this state of affairs, which can be attributed to a specific water content in the reactor, is made already in U.S. Pat. No. 2,599,620.

In order to keep the water content as low as possible, the expensive corresponding sodium salt is used in part instead of the monochloroacetic acid. As a result the neutralisation water produced during neutralisation is excluded.

A further disadvantage of the known methods is that frequently no visually completely soluble products are produced.

It is the object of the invention to make available a method for producing highly substituted carboxyalkyl starch using reagents and solvent systems which are as economical as possible. During the reaction, the reaction mixture should thereby not agglutinate and the corresponding products should be clearly soluble with substitution rates between 0.3 and 2. With respect to economic and ecological aspects, the yield should be as high as possible.

The object is achieved by the characterising features of claim 1. The sub-claims display advantageous developments.

It is thus proposed according to the invention that the starch is converted with halogenated acids in an organic-aqueous reaction medium in the presence of alkali hydroxide up to substitution rates of 0.3 to 2. The method is characterised in that the halogenated acid is dissolved initially in a reaction medium containing max. 10% H₂O and is partially or completely neutralised by adding anhydrous alkali hydroxide, subsequently the starch is suspended in this reaction medium and, by adding concentrated aqueous alkali hydroxide and/or anhydrous alkali hydroxide and by increasing the temperature, is carboxyalkylated.

An anhydrous medium which can however be mixed with water is used preferably to dissolve the halogenated acid.

In order to obtain visually completely soluble products in 2% aqueous solution, it has proved to be advantageous to use amylopectin-rich starch and/or pure amylopectin. Potato starch, wheat starch, rice starch, maize starch, barley starch or tapioca starch or mixtures thereof can also be used as starch. In the case of the halogenated acids, monochloroacetic acid, monochloropropionic acid and/or chloromalonic acid are preferred.

C1-C4 alcohols, preferably 2-propanol, are particularly suitable as reaction medium. The conversion is implemented expediently at a temperature of 30-80° C., preferably 35-70° C.

In order to implement the method according to the invention, the halogenated acid, preferably monochloroacetic acid, is dissolved firstly in the alcoholic reaction medium and partially or completely neutralised with anhydrous alkali hydroxide. The mol ratio of halogenated acid to starch is thereby 0.5:1 to 3:1 and the mol ratio of alkali hydroxide added in total to halogenated acid is between 2.5:1 and 2:1.

After 3-4 hours the reaction is ended and the product is washed with 70-100% methanol, preferably 80%, until free of chloride and subsequently is dried.

The carboxyalkylation according to the invention is undertaken up to a substitution rate of 0.3-2, preferably 0.5-1.5.

Since, in the case of the preceding neutralisation of the halogenated acid in the reaction medium, initially the sodium salt of the acid, for example monochloroacetic acid, is precipitated, it was not to be expected for the person skilled in the art that the heterogeneously occurring reaction components react in such a manner that high substitution rates are achieved with high reagent yields and at the same time qualitatively high value carboxyalkyl starches are obtained.

The method according to the invention differs from known solutions in that, in a one-pot method, carboxyalkyl starch can be produced with high substitution rates between 0.3 and 2.

The method for monochloroacetic acids is preferred so that carboxymethyl starch results.

It is crucial thereby that the used halogenated acid, which is dissolved in the reaction medium, for example monochloroacetic acid, is initially partially or completely neutralised with solid sodium hydroxide. The subsequently added starch is carboxymethylated by adding aqueous caustic soda solution or anhydrous alkali hydroxide. This sequence of reagent and substrate dosages makes possible good checking of the water supply in the reaction system and consequently prevents the agglutination during the reaction. In the first neutralisation step, solid sodium hydroxide is used in order not to introduce additional water into the system. In the second step, aqueous caustic soda solution is used because a better dispersion is ensured as a result than with solid sodium hydroxide pellets. According to the invention, fine sodium hydroxide prills can be used here also.

The method according to the invention offers furthermore economic advantages by using for example the free monochloroacetic acid instead of the correspondingly more expensive sodium salt.

By means of the slurry process control there are produced substantial economic advantages during processing and washing of the product relative to the method in solution.

When using amylopectin-rich starch or pure amylopectin, products can be obtained which are visually completely soluble in aqueous solution.

The invention is explained subsequently in more detail by means of a comparative example and four embodiments.

### EXAMPLE 1 (comparative example)

73.0 g wax maize starch (water content 88.8%) are placed first in a suitable reactor in 600 ml 2-propanol and mixed with a solution of 156.4 ml of 45% aqueous sodium hydroxide with an operating agitator. After 1.5 hours, 75.6 g monochloroacetic acid are then added. Hereupon, heating takes place to 50° C. The product begins to agglutinate after 1.2 hours and can no longer be agitated. The experiment must therefore be concluded.

### EXAMPLE 2

56.7 g monochloroacetic acid are dissolved in 600 ml 2-propanol in a suitable reactor with an operating agitator and mixed with 24.0 g anhydrous sodium hydroxide. During thorough mixing, 73.0 g wax maize starch (water content 88.8%) are then added and subsequently 64.0 g 45% aqueous sodium hydroxide are added in drops. Hereupon, heating takes place to 50° C. and this temperature is maintained for 3 hours. Thereafter, the reactor is cooled and the product is neutralised with 50% methanolic acetic acid, washed with 80-100% methanol and dried in the vacuum-drying cabinet.

A fine-grained white carboxyalkyl starch is obtained which dissolves visually clearly and completely in water. The substitution rate is 1.19 which corresponds to a reagent yield of 79%. The measured viscosity of a 2% aqueous solution with a shearing rate of 2.55 s⁻¹ is 5700 mPas.

### EXAMPLE 3

56.7 g monochloroacetic acid are dissolved in 600 ml 2-propanol in a suitable reactor with an operating agitator and mixed with 24.0 g anhydrous sodium hydroxide. During thorough mixing, 73.0 g wax maize starch (water content 88.8%) are then added and subsequently 64.0 g 45% aqueous sodium hydroxide are added in drops. Hereupon, heating takes place to 40° C. and this temperature is maintained for 4 hours. Thereafter, the reactor is cooled and the product is neutralised with 50% methanolic acetic acid, washed with 80-100% methanol and dried in the vacuum-drying cabinet.

A fine-grained white carboxyalkyl starch is obtained which dissolves visually clearly and completely in water. The substitution rate is 1.13 which corresponds to a reagent yield of 75%. The measured viscosity of a 2% aqueous solution with a shearing rate of 2.55 s⁻¹ is 7800 mPas.

### EXAMPLE 4

56.7 g monochloroacetic acid are dissolved in 600 ml 2-propanol in a suitable reactor with an operating agitator and mixed with 24.0 g anhydrous sodium hydroxide. During thorough mixing, 72.4 g potato starch (water content 89.6%) are then added and subsequently 64.0 g 45% aqueous sodium hydroxide are added in drops. Hereupon, heating takes place to 40° C. and this temperature is maintained for 4 hours. Thereafter, the reactor is cooled and the product is neutralised with 50% methanolic acetic acid, washed with 80-100% methanol and dried in the vacuum-drying cabinet.

A fine-grained white carboxyalkyl starch is obtained which dissolves completely in water. The substitution rate is 1.06, which corresponds to a reagent yield of 71%. The measured viscosity of a 2% aqueous solution with a shearing rate of 2.55 s⁻¹ is 2100 mPas.

### EXAMPLE 5

94.5 g monochloroacetic acid are dissolved in 700 ml 2-propanol in a suitable reactor with an operating agitator and neutralised with 88.9 g 45% aqueous sodium hydroxide. During thorough mixing, 91.3 g wax maize starch (water content 88.8%) and subsequently 48.0 g anhydrous sodium hydroxide are then added. Hereupon, heating takes place to 40° C. and this temperature is maintained for approximately 4 hours. Thereafter the reactor is cooled and the product is neutralised with 50% methanolic acetic acid, washed with 80-100% methanol and dried in the vacuum-drying cabinet.

A fine-grained white carboxyalkyl starch is obtained which dissolves visually clearly and completely in water. The substitution rate is 1.35, which corresponds to a reagent yield of 68%. The measured viscosity of a 2% aqueous solution with a shearing rate of 2.55 s⁻¹ is 14000 mPas.

1. Method for producing highly substituted carboxyalkyl starch by converting starch with halogenated acids in an organic-aqueous reaction medium in the presence of alkali hydroxide, characterised in that the halogenated acid is dissolved firstly in a reaction medium containing up to max. 10% H₂O and is neutralised partially or completely by adding anhydrous alkali hydroxide, subsequently the starch is suspended in this reaction medium and is carboxyalkylated by adding concentrated aqueous alkali lye and/or anhydrous alkali hydroxide.

2. Method according to claim 1, characterised in that the halogenated acid is dissolved in an anhydrous reaction medium which can be mixed with water.

3. Method according to claim 1 or 2, characterised in that potato starch, wheat starch, rice starch, maize starch, barley starch, tapioca starch or mixtures thereof are used as starch.

4. Method according to claim 1 to 3, characterised in that amylopectinrich starch and/or pure amylopectin is used as starch.

5. Method according to claim 1 to 4, characterised in that monochloroacetic acid, monochloropropionic acid and/or chloromalonic acid or esters thereof are used as halogenated acid.

6. Method according to claim 1 to 5, characterised in that C1 to C4 alcohols, preferably 2-propanol, are used as reaction medium which can be mixed with water.

7. Method according to claim 1 to 6, characterised in that the conversion is implemented at temperatures between 30 and 80° C.

8. Method according to claim 7, characterised in that the conversion is effected at 35 to 70° C.

9. Method according to claim 1 to 8, characterised in that the mol ratio of halogenated acid to starch is 0.5:1 to 3:1 and the mol ratio of alkali hydroxide added in total to halogenated acid is 2.5:1 to 2:1.

10. Method according to claim 1 to 9, characterised in that the reaction product is possibly neutralised, washed with a water-containing or anhydrous C1 to C3 alcohol and subsequently is dried.
